(19) United States
(12) Patent Application Publication
(10) Pub. No.: US 2009/0127069 A1
(43) Pub. Date: May 21, 2009

(54) Device and Method for Transporting an Object by Means of a Supporting Component

(75) Inventor: Peter Enenkel, Konstanz (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munchen (DE)

(21) Appl. No.: 12/275,609

(22) Filed: Nov. 21, 2008

(30) Foreign Application Priority Data
Nov. 21, 2007 (DE) 10 2007 055 671.5

(51) Int. Cl. B65G 37/00; B65G 43/08

(52) U.S. Cl. 198/341.01; 198/346.2

(57) ABSTRACT

A device and a method for transporting an object to a processing device by way of a supporting component. The processing device has a base and a side wall. The advancing device has a supporting component for carrying the object, a displacing component, and an activating component. The supporting component can be moved in an advancing direction toward the processing device. A slot has been formed into the side wall of the processing device. The displacing component is embodied for moving the supporting component transversally or obliquely to the advancing direction through the slot. The activating component is embodied for activating the displacing component in such a manner that the displacing component will move the support device through the slot and the side wall will sweep an object located on the support device off the support device so that the swept-off object will drop onto the base of the processing device.

### CROSS-REFERENCE TO RELATED APPLICATION

This application claims the priority, under 35 U.S.C. §119, of German application DE 10 2007 055 671.5, filed Nov. 21, 2007; the prior application is herewith incorporated by reference in its entirety.

### BACKGROUND OF THE INVENTION

1. Field of the Invention

The invention relates to a device and a method for transporting an object to a processing device by means of a supporting component. The object is, for example, a stack of flat items of mail and the processing device is, for example, a singularizing device of a mail sorting system.

German patent DE 195 45 726 C1 describes a device for automatically feeding a singularizing device of a mail sorting system. That is, there is described an advancing device for advancing an object (St) to a processing device, wherein the the processing device has a base (10) and a lateral boundary (11), the advancing device has a supporting component (1) for carrying the object (St), and the supporting component (1) can be moved in an advancing direction (Z) toward the processing device. The device executes a method for advancing an object (St) to a processing device, wherein the object (St) is placed onto a supporting component (1), and the supporting component (1) and object (St) are moved in an advancing direction (Z) toward the processing device.

The stack of items of mail is placed onto a mail receptacle of the device known from DE 195 45 726 C1 and moved by a conveyor belt toward the singularizing device. The stack is therein supported by an arrangement of separating blades. The separating blades can be moved in and counter to the advancing direction.

German patent DE 195 40 992 C2 describes a device that not only advances flat objects but also loosens them. What therein functions as a processing device is the loosening path that has a base and a lateral boundary. Spindle threads are let into the base and lateral boundary for the purpose of loosening. The pitch of the spindle threads increases viewed in the advancing direction. Synchronized turning of the spindle threads causes items of mail positioned on the base and among which the flanks of the spindles engage to be both transported and loosened. “Loosened” means that the distances between the items of mail—viewed in the transporting direction—are increased. Loosening makes it easier to align the items of mail on the base and against the lateral boundary.

If the spindle threads described in DE 195 40 992 C2 have been let into the base of the processing device known from DE 195 45 726 C1, then it will not be possible to move the items of mail across and beyond the spindle threads.

Advancing devices, in particular for flat items of mail, are further described in European patent EP 0877656 B1, U.S. Pat. No. 5,271,710, German published patent application DE 197 42 367 A1, and European patent EP 0750583 B1.

### SUMMARY OF THE INVENTION

It is accordingly an object of the invention to provide a device and a method for transporting objects by way of a supporting component which overcomes the above-mentioned disadvantages of the heretofore-known devices and methods of this general type and which will allow an object located on the supporting component to be advanced even when constituents across which the object cannot be moved away without having to be lifted or sustaining damage have been let into the base.

With the foregoing and other objects in view there is provided, in accordance with the invention, an advancing device for advancing an object to a processing device, the processing device having a base and a lateral boundary, the advancing device comprising:

a supporting component for carrying the object, said supporting component being configured for movement in an advancing direction toward the processing device;

wherein the lateral boundary of the processing device has a slot formed therein;

a displacing component configured for moving said supporting component transversely or obliquely to the advancing direction through the slot; and

an activating component configured for activating said displacing component to move said supporting component through the slot and to cause the lateral boundary to sweep an object disposed on said supporting component off said supporting component and onto the base of the processing device.

With the above and other objects in view there is also provided, in accordance with the invention, a method for advancing an object to a processing device, the processing device having a base and a lateral boundary, the method which comprises:

placing an object onto a supporting component;

moving the supporting component and the object in an advancing direction toward the processing device;

generating a signal to thereby trigger a step wherein the supporting component is moved transversely or obliquely to the advancing direction through a slot in the lateral boundary; and

sweeping the object with the lateral boundary off the supporting component by way of the movement of the supporting component, to thereby drop the object onto the base of the processing device.

The invention relates to a device and a method for transporting an object to a processing device by means of a supporting component. The processing device has a base and a lateral boundary. The advancing device has a supporting component for carrying the object, a displacing component, and an activating component. The supporting component can be moved in an advancing direction toward the processing device. Let into the lateral boundary of the processing device is a slot. The displacing component is embodied for moving the supporting component transversally or obliquely to the advancing direction through the slot. The activating component is embodied for activating the displacing component in such a manner that the displacing component will move the support device through the slot and the side wall will sweep an object located on the support device off the support device so that the swept-off object will drop onto the base of the processing device.

The inventive embodiment wherein the supporting component is moved as soon as the object has reached another ahead of it, for example, insures that the supporting component will then no longer be in the way and will not impede further processing of the object.

Moving of the supporting component is preferably triggered by a sensor. The sensor generates a signal when the object has been moved down to a minimum distance apart from another ahead of it. That embodiment will save having to activate the displacing component manually.

Other features which are considered as characteristic for the invention are set forth in the appended claims.

Although the invention is illustrated and described herein as embodied in device and method for transporting an object by means of a supporting component, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a perspective view of the device with the supporting component in the loading position;

FIG. 2 is a perspective view of the device shown in FIG. 1 with the supporting component loaded;

FIG. 3 is a perspective view of the device shown in FIG. 2 with the loaded supporting component having been moved up to the stack ahead of it;

FIG. 4 is a perspective view of the device shown in FIG. 3 with a laterally moved supporting component;

FIG. 5 is a top plan view of the device shown in FIG. 4.

### DETAILED DESCRIPTION OF THE INVENTION

In the exemplary embodiment the device is employed in a singularizing system of a mail sorting system. The object requiring to be advanced is a stack of flat items of mail. The singularizing system includes the following components arranged, as viewed in an advancing direction Z, downstream one behind the other:
an advancing device having a supporting component,
an aligning device, and
an extracting device.

The supporting component has a level, preferably rectangular support surface. It can be moved in the advancing direction Z.

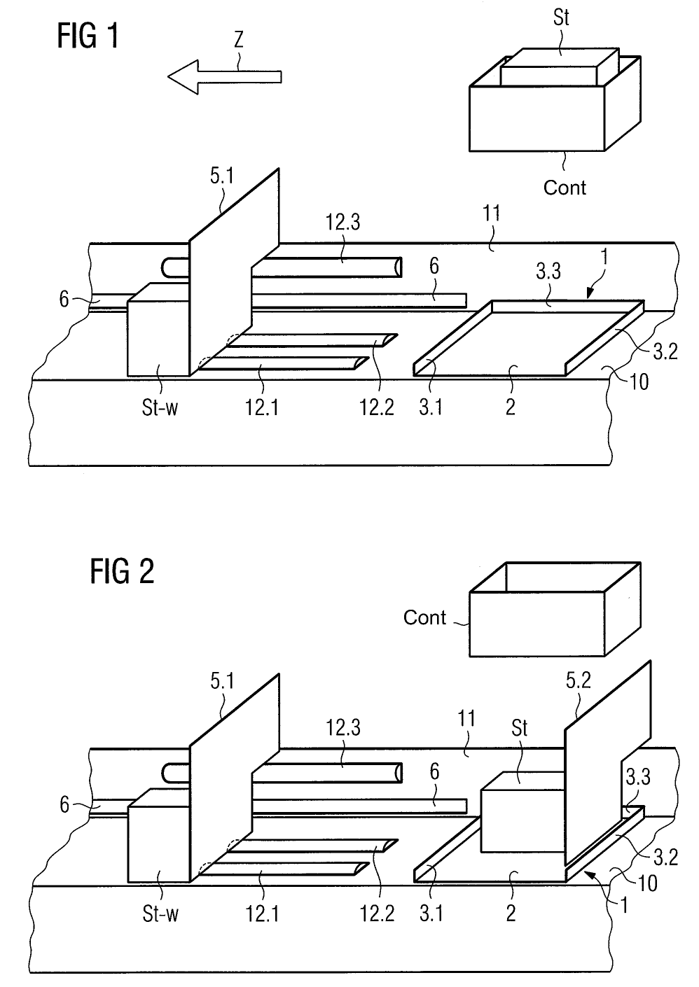

Referring now to the figures of the drawing in detail and first, particularly, to FIG. 1 thereof, the aligning device includes a base 10 and a side wall 11. The side wall defines a lateral boundary 11 standing perpendicular on the base 10. The base 10 is preferably inclined, specifically down to the edge where the base 10 and side wall 11 border one another.

FIG. 1 shows the advancing device in the exemplary embodiment, with the supporting component 1 being in a loading position. In that position an object—in this case a stack St of flat mail items—can be placed onto the level aligning surface 2.

Alongside the level and rectangular support surface 2 the supporting component 1 preferably includes a plurality of lateral boundaries 3.1, 3.2, 3.3 that prevent the stack St being supported from slipping off the support surface 2. For example there is a side wall 3.1 on the front boundary line of the support surface 2 (viewed in the advancing direction Z), a side wall 3.2 on the back boundary line, and a side wall 3.3 on a side wall line of the support surface 2. The side wall line is preferably that facing the side wall 11 of the aligning device. Unimpeded access is therefore possible to the supporting component 1 from the other side because the supporting component 1 does not have a lateral boundary on that side.

The stack St of flat items of mail is removed from the container Beh and placed onto the supporting component 1 such that the items of mail will be arranged approximately vertically. The plane in which an item of mail extends is therefore approximately perpendicular to the support surface 2 and perpendicular to the advancing direction Z that points toward the extracting device. Shown in FIG. 1 is the stack St in the container Beh. The mount that carries the filled container Beh has been omitted for the sake of clarity.

FIG. 2 shows the device shown in FIG. 1 with the supporting component 1 loaded in the loading position.

The supporting component 1 is moved along with the stack St in the advancing direction Z. The stack St is then taken from the supporting component 1 to the base 10 of the aligning device. As a rule the stack St will then be located behind another stack St-w previously taken to the base 10 of the aligning device. How said stacks are taken to said base is described further below.

Two spindle threads 12.1, 12.2 are let into the base 10 and a spindle thread 12.3 is let into the side wall 11 of the exemplary embodiment. The pitches of said spindle threads 12.1, 12.2, 12.3 preferably increase, viewed in the advancing direction, for example in the manner known from the above-referenced German patent DE 195 40 992 C2.

The aligning device furthermore has a non-illustrated shaker that causes the base 10 and/or side wall 11 to vibrate. The work performed by the aligning device will cause the items of mail to be aligned on the base 10 and against the side wall 11 and, furthermore, will cause mutually adhering items of mail to be separated.

The aligned items of mail are advanced in the stack St to the extracting device. The device extracts in each case one item of mail from the stack St and transports it in an extraction direction that is perpendicular to the advancing direction Z. The extracting device thereby generates a stream of successive items of mail separated by a gap.

The advancing device is described in more detail below. It preferably includes two propping devices, or prop-up elements, in the form of two separating blades 5.1, 5.2. The separating blades 5.1, 5.2 are swivel-mounted, for example they can be turned or moved. The separating blades 5.1, 5.2 can both be put into a propping position in which they are located in front of or behind a stack St positioned on the support surface 2. The distance between the two separating blades 5.1, 5.2 can be changed and thereby matched to the extent of the stack in the advancing direction Z. The separating blades 5.1, 5.2 are both moved in the advancing direction Z along with the stack St between them.

The separating blade 5.1 is located in the example shown in FIG. 1 et seq. behind the other stack St-w and in front of the stack St. It is in all figures in the propping position. The separating blade 5.2 is not shown in FIG. 1 and is in FIG. 2 et seq. located in the propping position behind the stack St.

The separating blades 5.1 and 5.2 are both secured to mounts, for example a shaft, such that they can be turned or otherwise swiveled. Said mounts have been omitted from the figures for the sake of clarity.

The supporting component 1 can be moved in the advancing direction Z. Because the stack St is positioned on the supporting component 1, moving the supporting component 1 along with the stack St will cause the supporting component 1 to be moved in the advancing direction Z. It is moved to an extent such as to be positioned over the base 10 and over the side wall 11 of the singularizing device. As already mentioned, two spindle threads 12.1, 12.2 of the aligning device have in the exemplary embodiment been let into said base 10 and one spindle thread 12.3 into the side wall.

During ongoing operation there is already another stack St-w in the aligning device that was taken thereto ahead of the stack St still on the supporting component 1 and which is also aligned and singularized ahead and/or simultaneously. The new stack St, meaning the one still on the supporting component 1, should reach the base 10 of the aligning device as closely as possible behind the other stack St-w.

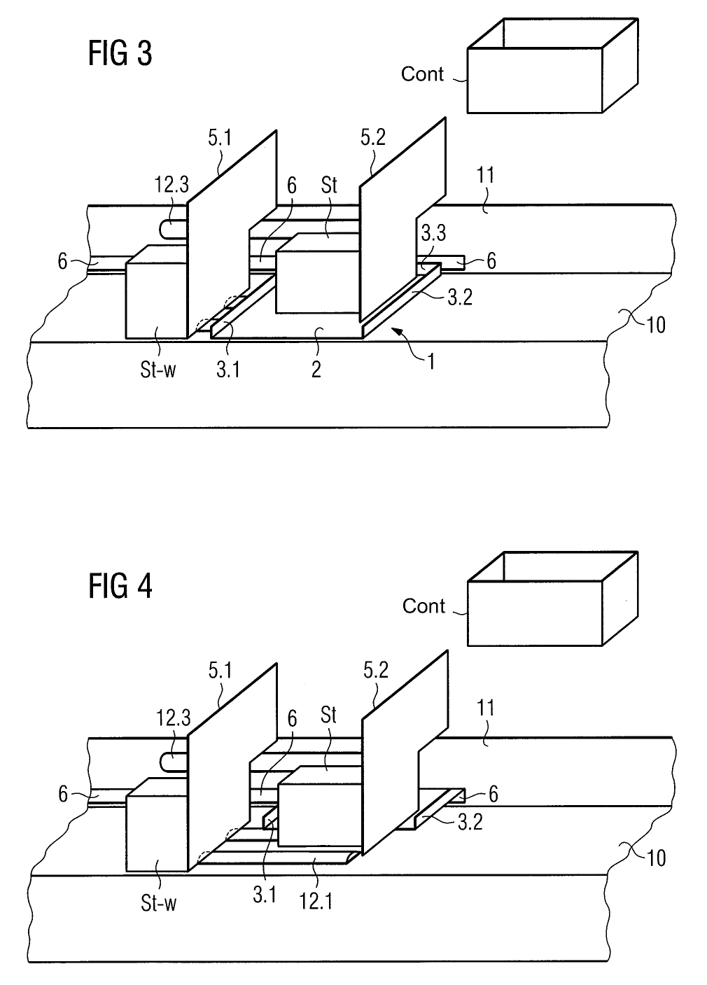

FIG. 3 shows the device shown in FIG. 2. The supporting component 1 along with the stack St and back separating blade 5.2 has, though, compared with FIG. 2 been moved up to the stack St-w ahead of it.

In the exemplary embodiment the advancing device includes a position sensor. Said sensor generates a signal when the new stack St is closely behind the other stack St-w, with the new stack St-w still being located on the supporting component 1 and the other stack St-w already being on the base 10 of the aligning device. “Close” means that the distance between the following (new) stack St and the other stack St-w ahead of it is less than a predefined limit.

In a first embodiment variant the position sensor is moved along with the supporting component 1 and hence also together with the stack St. The sensor is in the first embodiment variant preferably permanently linked to the supporting component 1.

In another embodiment variant the sensor is let into the base 10 or lateral boundary 11 and is moved, for example, along with the front separating blade 5.1.

The sensor preferably includes a projective element, for example a finger approximately 10 cm in length. Said projective element projects perpendicularly to the advancing direction Z from the side wall 11. A spring retains it in its rest position. If the stack St is close behind the other stack St-w, the projective element will be twisted counter to the spring resistance and the signal triggered thereby.

In the first embodiment variant, wherein the sensor is moved along with the supporting component 1, the signal is triggered as a result of the projecting element of the moved sensor touching the other stack St-w. In the other embodiment variant, wherein the sensor is moved along with the front separating blade 5.1, the signal is by contrast triggered through touching of the projecting element by the moved supporting component 1 or the moved following stack St.

The figures show a situation in which another stack St-w is located in front of the stack St. What, though, is also possible is for the sorting system to be in the process of resuming its operation so that the stack St will be the first one requiring to be processed. There will in that case be no stack St-w ahead from which the stack St could be spaced apart a slight distance.

An end position is therefore predefined to allow for that eventuality. The signal will be triggered also when the supporting component 1 has along with the stack St been moved in the advancing direction Z to an extent such as to reach the end position. The supporting component 1 or stack St will touch the projecting element if the other embodiment variant has been realized. In the first embodiment variant an activation element has been let into the base 10 or side wall 11. The projective element will touch the activation element at the instant at which the supporting component 1 reaches the end position.

The advancing device furthermore includes a displacing component as well as a synchronizing component that is linked to the sensor and displacing component. The synchronizing component will activate the displacing component on receipt of the signal. The displacing component moves the supporting component 1 in a displacement direction transversally or obliquely to the advancing direction Z. There is an angle between the displacement direction and advancing direction Z that is greater than 0 degrees, preferably greater than or equal to 45 degrees, and less than 180 degrees. The angle is preferably 90 degrees, meaning that the displacing component will pull the supporting component 1 away at right angles to the advancing direction Z. An angle greater than 90 degrees will cause the displacing component to move the supporting component 1 obliquely backward.

In one embodiment variant the displacing component includes a pretensioned spring. A retaining element retains the spring in its pretensioned position. The spring is mechanically linked to the supporting component 1. The signal will cause the retaining element to be deactivated and the spring to release the potential energy it stores owing to the tension and thereby move the supporting component 1. For example the projective element is linked to the retaining element. Turning the projective element through at least a minimum angle will cause the retaining element to be deactivated. Said turning of the projective element is in that embodiment variant the trigger for the signal.

In another embodiment variant the displacing component has an electric drive, for example an actuator. The sensor generates an electric signal. The synchronizing component activates the drive after receipt of the signal. Said drive moves the supporting component 1.

A slot 6 has been let into the side wall 11. Said slot 6 extends in the exemplary embodiment parallel to the spindle threads 12.1, 12.2, and 12.3 and parallel to the edge between the base 10 and side wall 11. The slot 6 is sufficiently high to allow the supporting component 1 with the lateral boundaries 3.1, 3.2, and 3.3 to be moved through it. The slot 6 is sufficiently long to allow the supporting component 1 to be moved through it in any position between the loading position shown in FIG. 1 and the end position.

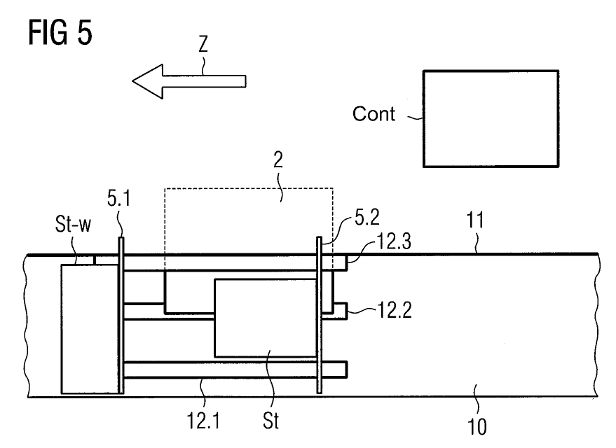

As just explained, the displacing component moves the supporting component 1 transversally or obliquely to the advancing direction Z. In the example shown in FIG. 3 the supporting component 1 is moved perpendicularly to and to the right of the advancing direction Z, specifically into the plane of the drawing. FIG. 4 shows the supporting component 1, more than half of which has already been moved through the slot 6. FIG. 5 shows the device shown in FIG. 4 from above.

Moving the supporting component 1 causes the stack St on the support surface 2 to be swept off the supporting component. The supporting component 1 fits through the slot 6. The slot 6 is, though, narrower than the items of mail standing upright. The side wall 11 thus sweeps the items of mail in the stack St off the supporting component 1. On account of their intrinsic weight the swept-off items of mail will drop onto the base 10 of the aligning device and hence onto the spindle threads 12.1, 12.2 let into the base 10. The flanks of said spindle threads 12.1, 12.2 engage between the items of mail in the stack St.

The base 10 is preferably inclined down to the slot 6. In that embodiment their intrinsic weight will also move the items of mail toward the side wall 11. The flanks of the spindle thread 12.3 let into the side wall 11 will then also engage between the items of mail. The spindle threads 12.1, 12.2, 12.3 turn at the same turning speed and will move the items of mail in the advancing direction Z.

As already mentioned, the aligning device has a shaker that causes the base 10 and/or side wall 11 to vibrate. In one embodiment the shaker operates permanently. In another embodiment the signal from the position sensor additionally causes the shaker to be activated.

After being moved, the supporting component 1 is located completely behind the side wall 11, meaning the lateral boundary 11 is located between the supporting component 1 and the stacks St and St-w. A fetch-back component fetches the supporting component 1 from behind the side wall 11 back into the loading position. In one embodiment the fetch-back component simultaneously tensions the spring in the displacing component.

The fetch-back component first moves the supporting component 1 counter to the advancing direction Z then moves it through the slot 6 so that the supporting component 1 will thereafter again be in the loading position as shown in FIG. 1. Another stack can then be placed onto the supporting component 1.

After the displacing component has moved the supporting component 1 through the side wall 11 the front separating blade 5.1 will be located between the stack St and the other stack St-w. Both separating blades 5.1, 5.2 are preferably moved counter to the advancing direction Z so that the front separating blade 5.1—viewed in the advancing direction Z—will be located behind the stack St and the back separating blade 5.2 will be located behind the supporting component 1.

In the exemplary embodiment the displacing component was activated automatically by means of a sensor. In an alternative embodiment the displacing component is activated manually, for example through a user's pressing a button. Pressing said button triggers the process of the displacing component's moving the supporting component 1 laterally.

1. An advancing device for advancing an object to a processing device, the processing device having a base and a lateral boundary, the advancing device comprising:
a supporting component for carrying the object, said supporting component being configured for movement in an advancing direction toward the processing device;
wherein the lateral boundary of the processing device has a slot formed therein;
a displacing component configured for moving said supporting component transversely or obliquely to the advancing direction through the slot; and
an activating component configured for activating said displacing component to move said supporting component through the slot and to cause the lateral boundary to sweep an object disposed on said supporting component off said supporting component and onto the base of the processing device.

2. The advancing device according to claim 1, wherein said activating component comprises:
a sensor for generating a signal when an object disposed on said supporting component is moved in the advancing direction to such an extent that a distance between the object and another object disposed on the base of the processing device is less than a predefined minimum distance;
a synchronizing component connected to receive an output signal from said sensor, said synchronizing component activating said displacing component after receiving the output signal to move said supporting component through the slot in the lateral boundary.

3. The advancing device according to claim 2, wherein said sensor is rigidly connected to said supporting component and said sensor is jointly movable with said supporting component in the advancing direction.

4. The advancing device according to claim 2, wherein said sensor is let into the lateral boundary or the base of the processing device.

5. The advancing device according to claim 2, wherein said sensor is configured to generate the output signal when the object is moved in the advancing direction to such an extent that the distance between an object on the supporting component and a downstream end of the processing device becomes less than a further minimum distance.

6. The advancing device according to claim 1, which further comprises a fetch-back component configured to transport said supporting component, after movement thereof through the slot, counter to the advancing direction and into a position for receiving a further object.

7. The advancing device according to claim 1, which further comprises at least one propping component disposed for movement counter to the advancing direction and pivotable into a propping position and out of the propping position, said propping component, upon being placed in the propping position located in front of or behind an object on said supporting component, viewed in the advancing direction, preventing the object from being moved in or counter to the advancing direction.

8. A processing system with a processing device for processing an object, comprising:
a base;
a side wall disposed to form a lateral boundary, said side wall having a slot formed therein; and
an advancing device according to claim 1 for delivering the object to the processing device.

9. A delivery method, which comprises:
providing an advancing device according to claim 1; and
advancing a stack of flat items of mail to a processing device.

10. A method for advancing an object to a processing device, the processing device having a base and a lateral boundary, the method which comprises:
placing an object onto a supporting component;
moving the supporting component and the object in an advancing direction toward the processing device;
generating a signal to thereby trigger a step wherein the supporting component is moved transversely or obliquely to the advancing direction through a slot in the lateral boundary; and
sweeping the object with the lateral boundary off the supporting component by way of the movement of the supporting component, to thereby drop the object onto the base of the processing device.

11. The method according to claim 10, which comprises generating the signal with a sensor when the object is moved in the advancing direction to such an extent that a distance between the object and a further object disposed on the base of the processing device is less than a predefined minimum distance.
